(19) United States
(12) Patent Application Publication
(10) Pub. No.: US 2009/0307757 A1
(43) Pub. Date: Dec. 10, 2009

(54) Method and System for Centralized Access Authorization To Online Streaming Content

(75) Inventor: Dirk Groten, Leiden (NL)

Correspondence Address: MICHAELSON & ASSOCIATES, P.O. BOX 8489, RED BANK, NJ, 07701-8489, US

(73) Assignee: Koninklijke KPN N.V., The Hague, (NL)

(21) Appl. No.: 11/922,608

(22) PCT Filed: Jun. 27, 2006
(86) PCT No.: PCT/EP2006/006212

§ 371 Date: Aug. 10, 2009

Related U.S. Application Data
(60) Provisional application No. 60/696,589, filed on Jul. 5, 2005.

(51) Int. Cl. H04L 29/06; H04L 9/32

(52) U.S. Cl. 726/4; 726/14

(57) ABSTRACT

The invention discloses a system to protect online streaming content by a content provider, by means of access authorization in the network operator's platform. The invention provides a solution to the problem of access authorization for streaming content, that is not exactly known with regards to description and/or location at the moment the access authorization is performed.

### FIELD OF THE INVENTION

The invention relates to an authorization system for online content. More specifically, the invention relates to a centralized authorization system for access to online streaming content.

### BACKGROUND OF THE INVENTION

It is known that a content provider can restrict access to online content, e.g. based on a username/password combination. For such an authorization method, the content provider needs to check the user identity and compare it e.g. to the subscription of the relevant user. The user database and technology facilitating this access control can become quite complex for the content provider from both a technological and managerial perspective and there is a danger of e.g. identity fraud, which can lead to financial damages.

A system that improves the protection against identity fraud is known from US 2004/0162787, in which a web server is introduced that cryptographically generates a ticket to be used in the access request to the media server (content provider).

It is also known that a content provider can protect downloadable online content by means of Digital Rights Management (DRM) methods. From WO 03/055219 a DRM system is known, using a management mechanism based on a content object and a rights object.

Also content brokering systems are known to facilitate the management of digital content of an Internet user. From WO 2005/024548 a system is known that facilitates identity management (i.e. sign-on federation), management of user devices and purchased content and replacement of purchased content on the user's behalf.

These known systems are mainly concerned with access or usage protection of downloadable online content.

Within the online content industry there is a need for the reduction of complexity for the content provider, whilst a high protection level for online content access needs to be achieved. The above-mentioned known technologies all need more or less complex technology and user identity management to be installed and managed by the content provider. This results in an increase of cost (technology and personnel) on top of the “core business” of content exploitation.

Especially a market for online streaming content is emerging, which is different in technology from downloadable content and which is also likely to result in new business rules. An important aspect related to online streaming content, for which existing technology provides no solution, is that at this moment no products are available that support authorization of streams (content objects) that are not exactly known as to their description and/or location at the moment the authorization is performed.

### PROBLEM DEFINITION

In the emerging market for online streaming content there is a need for a high level of protection against unauthorized access, without adding complexity to the content provider platform and it's operations. Furthermore, the merge of streaming content introduces new aspects related to access authorization that need to be addressed. An important aspect that needs to be addressed is that streams (or content objects) might not be exactly known with regards to description and/or location at the moment an access authorization is performed.

### AIM OF THE INVENTION

The aim of the invention is to be able to protect the online streaming content of a content provider, by means of access authorization in the network operator's platform. It is another aim of the invention to provide a solution to the problem of access authorization for streaming content, that is not exactly known with regards to description and/or location at the moment the access authorization is performed.

### SUMMARY OF THE INVENTION

The present invention discloses a method and system for access authorization to online streaming content from a content provider's platform. The access authorization is centralized and integrated in the network operator's platform, which makes it financially attractive because of economies of scale advantages over the use of separate authorization systems per content provider.

According to the invention access authorization can be performed for online streaming content, also when the description and/or location of the content is not known at the moment the access authorization is performed.

It is commonly known that network operators are able to offer a high level of user identity integrity to content providers.

According to an aspect of the invention, the identity of a mobile user is established by means of the Subscriber Identity Module. According to another aspect of the invention, the identity of a fixed line user is established by means of the Caller Line Identification (CLI).

These aspects of the invention ensure a high degree of identity integrity to the content provider, in contrast with e.g. a username/password combination.

By centralizing the access authorization in the network operator's platform, a cost-effective solution is achieved that provides a high level of identity integrity. This results in relatively low costs for access authentication and assures the rightful collection of usages fees by the content provider.

An advantage of the invention is that the content provider does not need to invest in dedicated access protection systems or Digital Rights Management systems for the use of access protection.

Another advantage of the invention is that the access control to online content by the network operator can be combined with billing of content usage on the content provider's behalf. In this case the content provider does not have to bill to each user separately.

### BRIEF DESCRIPTION OF THE DRAWINGS

The invention will be explained in greater detail by reference to exemplary embodiments shown in the drawings, in which:

FIG. 1 shows a system architecture according to the invention.

FIG. 2 shows a process description for “content discovery” and administration of access rights through a HTTP session.

FIG. 3 shows a process description for “content discovery” and administration of access rights through an RTSP “method”.

FIG. 4 shows a process description when a stream is started from the Media Player, including the steps for checking and administrating access rights.

FIG. 5 shows another process description for at least 3 situations that can occur when a stream is started from the Media Player.

### DETAILED DESCRIPTION OF THE INVENTION

For the purpose of teaching of the invention, preferred embodiments of the method and system of the invention are described in the sequel. It will be apparent to the person skilled in the art that other alternative and equivalent embodiments of the invention can be conceived and reduced to practice, the scope of the invention being only limited by the claims as finally granted.

It is commonly known that network operators are able to offer a high level of user identity integrity to content providers.

According to an aspect of the invention, the identity of a mobile user is established by means of the Subscriber Identity Module, which is a smart card that securely stores the key identifying a mobile subscriber to an Operator.

According to another aspect of the invention, the identity of a fixed line user is established by means of the Caller Line Identification (CLI), which is related directly to the user's physical connection (and physical address) in the Operator's local loop.

According to the invention access authorization can be performed for online streaming content, also when the description and/or location of the content is not known at the moment the access authorization is performed.

To facilitate the transport of online Streaming Content, a number of data protocols have been standardized, e.g. RTSP, RTP, IP multicast, RSVP and IGMP.

These protocols are designed to facilitate amongst others the control and transport of the streaming content. In relation to former downloadable content like e.g. HTTP pages, online streaming content is fundamentally different in character. This is mainly due to the “broadcast” character of the streaming content. In contrast to downloadable content like a web page, online streaming content can be “switched ON of OFF”. E.g. an online streamed TV show or Pop Concert (which can also be “transmitted” live), cannot be “downloaded”, but can be switched “ON or OFF” using suitable CONTROL commands or “methods” of an online streaming data protocol.

But also with respect to other aspects these online streaming data protocols are fundamentally different from “downloadable” data protocols like e.g. HTTP. When a user issues a request for online streaming content to a content provider, this generally results in more “steps” before the content is being transported, than in the case of (“simply”) downloadable content. Generally a HTTP web page containing a link (URL) or a “play list” is sent to the user by the content provider in response to a user's request. This play list contains details about the online streaming content like description and location. A play list might e.g. contain a number of links to different locations of songs from “Madonna”. After receiving the link or play list from the content provider, it is stored in the user device or PC, or a “Media player” is started which presents the play list to the user. Directly, or at any other time after the reception of the play list, the user can start a stream by selecting (“clicking”) one of the links in the play list from the Media Player.

According to the invention, the command (or “method”) that is used to start a stream from a play list is intercepted by the network operator and a check is carried out if the user has the right to access the stream from the content provider. The right to access the stream might e.g. be administrated in a user database of the network operator. But also an online check could be performed between the network operator and the content provider via cryptographically secured Internet connection, a dedicated connection like a leased line.

When the check result is positive, i.e. the user has the right to access the stream, the command (or “method”) to start a stream is forwarded to the content provider. After receiving the forwarded command to start a stream for a user from the network operator, the content provider starts sending the stream to the user with the appropriate data protocol.

When the check result is negative, i.e. the user does not have the right to access the stream, the command (or “method”) to start a stream is not forwarded to the content provider. According to an aspect of the invention an error message can be sent to the user by the network operator providing an error condition and/or explanation to the user, but also an opportunity can be offered by the network operator to the user to purchase the right to play the stream online. In both cases a HTTP page can be sent to the user to achieve this, the latter being a starting page for an interactive session. In this interactive session the user is offered access to the stream for a certain price. If the user accepts this offer, the initial command (or “method”) to start the stream is still forwarded to the content provider.

As an alternative to the present invention, the content provider would have to authorize each “start” of a stream from a specific user. This authorization per stream is very laborious with regards to e.g. hosting and management of content and the products to support this task in the content provider domain are expensive. Also the alternative of implementing a Digital Rights Management system is less attractive because of related implementation and operational costs.

According to a further aspect of the invention, a solution to a problem is disclosed, that will occur when a stream is being played by a user while the right to use the content is no longer valid.

When a user is e.g. watching a Pop Concert or Sports Event that is being streamed “live”, the stream could exist for a number of hours, days or more. After the user has been granted access to the online stream, according to an aspect of the invention, the expiration of the access right triggers a process to take appropriate action.

According to a further aspect of the invention, the appropriate action is to interrupt the stream. At the same moment an error message can be transmitted to the user, explaining that the access right has expired.

According to another aspect of the invention, the appropriate action is the starting of an interactive session to the user, in which the user is offered continuation of access to the stream for a certain price. If the user agrees, the payment is administrated and a link for the continuation of the stream is transmitted to the user. When the user clicks this link, the stream is started again.

A system according to the invention makes it possible to centralize the authorization of access to online streaming content for multiple content providers. The content providers do not have to implement access authorization into their own platform. A high level of identity integrity can be achieved when the centralized authorization is integrated into the network of a mobile or fixed network operator, which will reduce fraud damages for the content provider. Furthermore the invention provides for the denial of access to streaming content in case the right to access the content expires, which can be applied for e.g. streaming of live events.

The invention is applicable to any telecommunication network suitable for transport of streaming content, such as among others PSTN, ISDN, ADSL, “WiFi” (IEEE 802.11 protocol family), Cable, GSM, GPRS, Edge, UNTS, HSDPA, TDMA, CDMA. The following description uses GPRS as an example.

It can depend on the agreements between Operator and the specific content provider, if the starting of the stream is intercepted or not for that content provider. It could be done only in the case the specific content provider has an agreement with the operator to perform access authorization for it's streaming content. After the interception, the identity of the user is verified and the right to access the online streaming content is checked. When the identity check and the right to access the stream are valid, the original request is forwarded to the Content provider (CP) by the streaming proxy, after which the CP starts the stream for that user.

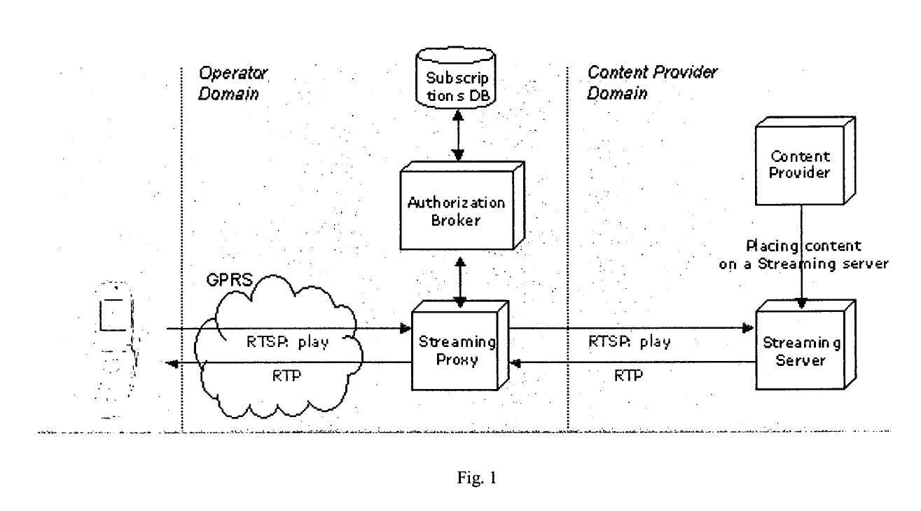

FIG. 1 shows a system architecture according to the invention. It shows the data and control flow from the user to the content provider and vice versa, through the Operator domain.

In the embodiment shown in FIG. 1, the stream is started using a RSTP “play method” and is intercepted by the operator by means of a Streaming proxy. The streaming proxy communicates with an authorization broker, which handles the verification of the user's identity (data/control flow not shown) and the verification of the right to access the stream.

In the embodiment as shown in FIG. 1, a mobile user is connected to the mobile network through GPRS. The user uses a Web browser for the access to HTTP pages and uses a Media player like e.g. Real Player or Microsoft Media Player for the playing of streaming content. The web browser and media player can be running on either a mobile phone or any other mobile device suitable for mobile communication, such as smart phones or palmtop computers with an integrated mobile phone or connected to a mobile phone be wire or wireless (e.g. by means of bluetooth). In case of a fixed network the media player can e.g. run on a Personal Computer, a “connected device” in a home network (e.g. palmtop computer with WiFi interface, a Media adapter connected to the TV, radio and/or other traditional Consumer Electronics (CE) equipment), Microsoft or other vendor's Media Center Edition personal computer, or a car radio or car TV with a mobile interface (e.g. WiFi or UMTS).

FIG. 1 shows the data and control flow from the user to the content provider and vice versa, through the operator network. The user through at least the following options can start a stream:
The user “clicks” on a link to a stream, which is presented as a URL in a web page, or
The user starts a stream from the Media player. The first option for starting a stream is normally realized by means of HTTP based “content discovery” by the user. I.e. the user is browsing web pages from the content provider, in which links (URL's) to streams or sets of links (“play lists”) are presented. To the choice of the content provider, the HTTP pages for content discovery, containing these links or play lists, can be freely accessible or billable content. In the latter case the Operator will prohibit the access to the content discovery pages if the user has no access right. Provided that the user has access to the content discovery pages, the content provider will sent a HTTP response (web page), that contains links and/or play lists of streaming content. The user then “clicks” (selects) one of the links from the HTTP page or “clicks” (selects) one of the entries from a play list from the Media Player, that can be set to start automatically (e.g. as a “plug-in”) on receipt of a play list in a HTTP page. Following either one of these cases a RTSP “PLAY” method (command) is sent to the content provider.

In the second option, content discovery is done through a RTSP session or one or more links or play lists for streaming content are already available to the user. In the latter case the user enters the link (URL) to the stream e.g. via the Web browser or “clicks” (selects) a stream from a play list from the Media Player's interface. The Media player will send an RTSP “PLAY” method (command) to the content provider. In the first case, content discovery is done through the Media Player, which sends a RTSP “DESCRIBE” method (command) to the content provider. The RTSP “DESCRIBE” method is forwarded to the content provider by the streaming proxy (provided access for this information is not protected/billed) and the content provider will respond with one or more links or play lists for streaming content. Following, the user selects a stream from the Media player interface and the Media player will send an RTSP “PLAY” method (command) to the content provider.

In both options, the operator intercepts the RTSP “Play” method. In the embodiment shown this is done by the Streaming proxy. The streaming proxy issues a request to an authorization broker. The authorization broker verifies the identity of the user (not shown) and checks the right to content access in a subscription database (Subscription DB).

The systems containing the streaming proxy, the authorization broker and the subscription database are logical representations. In alternative embodiments, the systems containing the streaming proxy and/or authorization broker and/or subscription database can also be combined in one system and/or one or more of these separate (logical) systems can be implemented in more than one physical system. This can be useful for either limiting the physical dimensions and/or operational costs in the case of small-scale implementations, or load balancing and/or stability in the case of large-scale implementations.

The identity is preferably checked by the operator by means of the user's SIM, in case of a mobile network, and by means of the CLI, in case of a fixed network. From the subscriber database the right to access the content is verified. This is e.g. done by checking a table, which holds the administration of rights per content provider and/or per URL.

If the identity check and authorization check results are positive, the original RTSP “Play” method is forwarded to the content provider. After receipt of the “Play” method, the content provider will start transmission of the stream and the streaming proxy forwards the stream to the user by means of the RTP protocol. When the Media Player receives the stream, it starts playing. This will normally continue until the user issues a “STOP” command to the media player, or until the stream is ended by the content provider (e.g. end of music clip).

If the identity check result is positive but the authorization check result is negative, an interactive session is started to allow the user to “buy” the right to access the content, as will be explained below.

If the identity check is negative, the operator blocks access to the content provider domain.

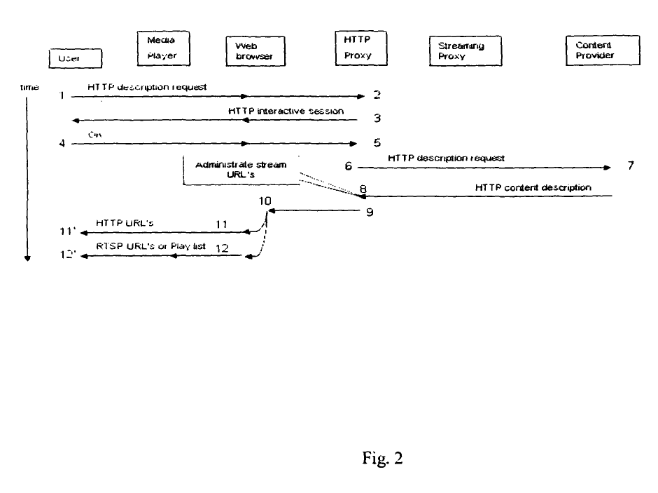

FIG. 2 shows a process description for “content discovery” and administration of access rights through a HTTP session. The timeline for events and steps is from top to bottom, as indicated by the arrow at the left side. As a first step (1), the user initiates the content discovery by clicking on a link or entering a link via the Web browser, after which the “description request” is sent to the content provider by the web browser. In the example shown the location in the content provider platform that is being accessed is access protected, i.e. the content provider has an agreement with the operator that the user is only allowed access after payment. The HTTP proxy intercepts the description request (2) and identity and access authorization is performed. In the case shown the access authorization check result is negative, i.e. the user has no access right for HTTP or RTSP content from the content provider. After establishment of this result, an interactive HTTP session to the user is started (3), in order to provide the option to the user to buy the right to access the requested content. Depending on the agreement between operator and content provider, specific tariffs can apply for specific content types, which content types can for example be separated and/or identified by means of separate URL's (“directories”) in the content provider platform. If the user refuses to pay for the requested access, the access to the content provider platform will remain blocked for that user and the HTTP description request will not be forwarded to the content provider. An additional error message to indicate this non-forwarding to the content provider can be sent to the user to avoid any doubt. If the user accepts to pay for the access, this is administrated by the operator in the subscription database by means of an “HTTP ticket”, with specific parameters as agreed between operator and content provider which can include amongst others the content location, description and expiration date and time for access. When it is the first time the user requests access to the content provider platform via the operator network, the administrated access rights are related to one or more HTTP links (URL's). After or during the administration of the access rights, the initial HTTP description request is forwarded to the content provider (6). After receipt (7) the content provider responds with the content description in a web page. The web page is intercepted by the HTTP proxy (8). At this point the content URL's contained in the web page are verified. If URL's are present that are not yet present in the subscription database as “accessible” content for the user, the URL's are added to the “HTTP ticket”. The added URL's can include HTTP URL's and/or RTSP URL's and/or other streaming content related URL's. In this way a flexible access control administration is achieved, that combines administration of access to downloadable content such as web pages with administration of access to streaming content. Each “entry” in a ticket for a specific user in relation to a specific content provider can contain it's own parameters like description, location, validity period. Alternatively, a ticket can use one or more parameters as general for all ticket entries, such as the validity period. This allows for flexibility in the agreement between operator and content provider, in order to facilitate the required business rules.

After or during the administration of the content access rights (“ticket administration”), the HTTP content description is forwarded to the user (9). The HTTP content description is received by the web browser (10), which either shows the web page (11) to the user (11′) or forwards the information to the Media Player (12), e.g. after the Media player is started as a plug-in.

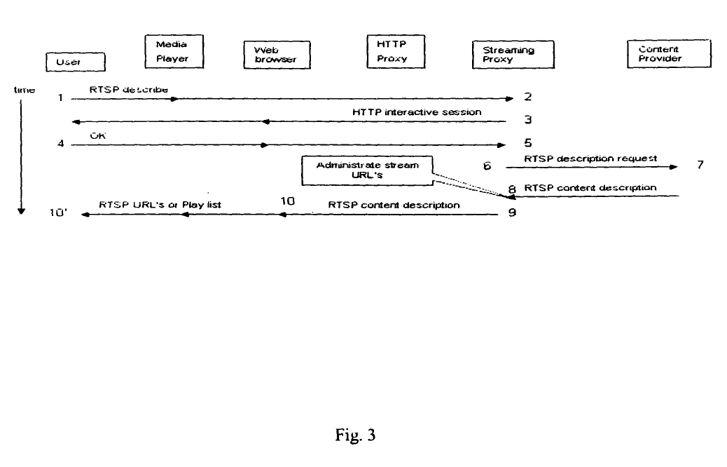

FIG. 3. Shows content discovery by means of a RTSP DESCRIBE “method”. In this case the Streaming proxy intercepts the request from the user and initiates the interactive session when the right to access the specified link on the content provider platform is not present in the subscriber database for the specific user. When the user agrees to the payment, the RTSP describe “method” is forwarded (6) and the content provider responds with an RTSP Content description (8). RTSP URL's and/or play lists present in the content description are added to the subscriber database. This can be done as a “ticket” similar to the HTTP ticket, but in this case only containing RTSP URL's. Alternatively, when a valid HTTP ticket is already present for the user for the specific content provider and a valid resemblance in parameters is present (such as validity period or and/or content location), the RTSP URL's can be added to the existing HTTP ticket. After or during the administration of the RTSP URL's, the RTSP content description is forwarded to the user (9) and displayed by the Media Player (10) to the user (10′).

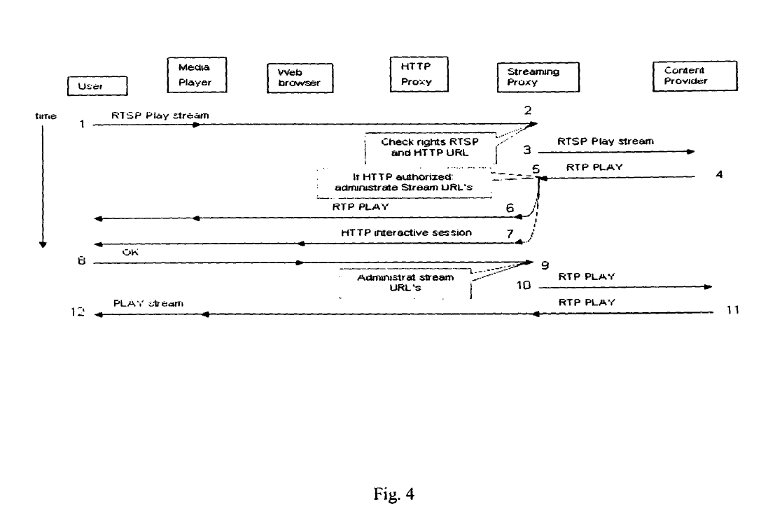

FIG. 4 shows a process description when a stream is started from the Media Player. The user starts a stream (1) via the Media Player interface. The resulting RTSP PLAY “method” is intercepted by the streaming proxy (2). The streaming proxy initiates the process of checking the user identity and content access right. When the identity check result is negative, the operator blocks access to the content provider. Provided the identity check result is valid, the subscription database is checked for valid access rights (“tickets”) to the requested RTSP URL. The access right is valid when sufficient resemblance in parameters is present (such as validity period or and/or content location). E.g. if the location (directory) of a valid HTTP ticket corresponds with the location (directory) of the RTSP URL, the access right can be valid when this corresponds with the agreement between operator and content provider about access admittance based on “location”. Such an agreement allows for example for access to al files corresponding with xxxx://musicclips/yyyy, after the access right to HTTP://musicclips/madonna/description has been purchased. Based on this purchase, within the validity period of the ticket, all files corresponding to RTSP://musicclips/Madonna/yyyy are accessible such as RTSP://musicclips/Madonna/holliday. But also other protocols in the first section of the URL can qualify under the corresponding HTTP ticket. Every time the right to access a specific RTSP URL is checked and the result is positive, the RTSP URL is added to the existing ticket. In this way, during the validity period of the ticket, an efficient and simple access authorization check can be performed. During or after the check and administration of the access rights, the RTSP Play “method” is forwarded to the content provider. The content provider starts the stream (4), and the corresponding streaming protocol transports the data back to the user (5).

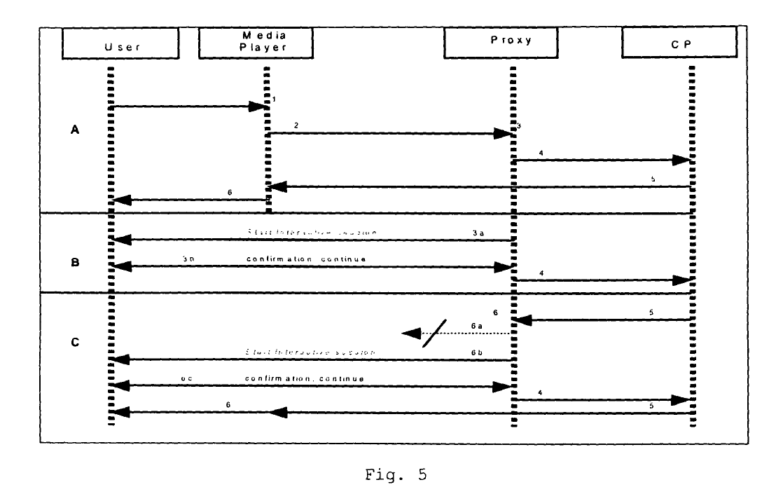

FIG. 5 shows another process description for at least 3 situations that can occur when a stream is started from the Media Player. Situation A depicts the process in case of a “positive flow”, i.e. the access authorization is positive and the stream is started. Situation B shows extra process steps on the event of a negative access authorization.

Situation C shows the process in case of the expiration of access authorization. This can occur when the user is watching a sporting event or pop concert that continues for hours, days or longer. When the access right “expires” during the playing of a stream, a process is triggered that blocks the stream (6a) to the user and starts an interactive HTTP session to the user to inform the user of the expiration and ask the user if he wants to acquire continued access to the streaming content (6b). If the users agrees, the user administration is updated (at least validity time of the subscription database, “ticket”) and a conformation page is sent to the user with the appropriate link (URL) to continue the stream (6).

1: System for access authorization to online streaming content, the system comprising access authorization means and access right administration means, the system elements being arranged such that
access authorization is integrated in an operator platform;
access authorization is performed for a multiple of content providers;
access right is administrated by means of tickets;
tickets comprising a set of parameters.

2: System according to claim 1, in which the said ticket parameters comprise
a content location;
a content description;
a validity period.

3: System according to claim 2, the system further comprising a user- or subscriber database, in which tickets are administrated, the tickets being related to access rights to online content.

4: System according to claim 3, in which the administration of said access rights in said tickets comprise said set of parameters.

5: System according to claim 4, in which the said parameters are specified by the operator and content provider.

6: System according to claim 5, in which one or more parameters in said set of parameters is/are equal for all tickets related to one content provider.

7: System according to claim 6, in which access to online content is admitted when there is resemblance between the URL in the content request and a ticket related to a valid access right in the user- or subscriber database.

8: System according to claim 7, in which sufficient resemblance is established when the protocol part of the URL in the content request is different from the URL in a ticket comprising a valid access right in the user- or subscriber database.

9: System according to claim 8, in which the accessed URL is added to the user- or subscriber database in a new ticket after access admittance, when the URL in the content request is not yet present in the user- or subscriber database.

10: System according to claim 1, in which HTTP traffic to online content providers is routed through a HTTP proxy.

11: System according to claim 10, in which a HTTP request to an online content provider is intercepted by a HTTP proxy.

12: System according to claim 11, in which access authentication is performed based on the URL in said intercepted HTTP request.

13: System according to claim 12, in which access authentication comprises comparing the URL in said intercepted HTTP request with tickets related to the user in the user- or subscriber database.

14: System according to claim 13, in which access authentication comprises an identity check involving a users SIM card.

15: System according to claim 1, in which access authentication comprises an online check between operator and online content provider.

16: System according to claim 10, in which a HTTP request is forwarded to a content provider when the access authorization result is positive.

17: System according to claim 10, in which a HTTP request is not forwarded to a content provider when the access authorization result is negative.

18: System according to claim 1, in which RTSP traffic to online content providers is routed through a streaming proxy.

19: System according to claim 18, in which a RTSP request to an online content provider is intercepted by the streaming proxy.

20: System according to claim 19, in which access authentication is performed based on the URL in said intercepted RTSP request.

21: System according to claim 18, in which an access authentication comprises a comparing of a URL in said intercepted RTSP request with tickets related to a user in the user- or subscriber database.

22: System according to claim 18, in which an access authentication comprises an identity check involving a users SIM card.

23: System according to claim 18, in which an access authentication comprises an online check between operator and online content provider.

24: System according to claim 18, in which a RTSP request is forwarded to a content provider when an access authorization result is positive.

25: System according to claim 18, in which a RTSP request is not forwarded to a content provider when an access authorization result is negative.

26: System according to claim 17, in which an interactive session is started to a user when an access authorization is negative.

27: System according to claim 26, in which an interactive session comprises exchange of HTTP pages between operator and user.

28: System according to claim 27, in which a user is provided an option to buy a right to access requested content.

29: System according to claim 28, in which a price for requested content is based on a specification by a content provider.

30: System according to claim 29, in which
a new ticket comprising a new valid access right is generated and stored in the user- or subscriber database;
the intercepted request is forwarded to the content provider;
when a user agrees to buy an access right.

31: System according to claim 30, in which a billing process is started in an operator platform which involves the price for an access right.
